(19) United States
(12) Patent Application Publication
(10) Pub. No.: US 2010/0208973 A1
(43) Pub. Date: Aug. 19, 2010

(54) RADIOLOGICAL IMAGING METHOD AND DEVICE

(76) Inventors: Jean Lienard, Igny (FR); Regis Vaillant, sur Yvette (FR); Benoit Leny, Buc (FR); Pierre-Luc Georgy, sur Yvette (FR)

Correspondence Address: General Electric Company;GE Global Patent Operation, 2 Corporate Drive, Suite 648, Shelton, CT, 06484, US

(21) Appl. No.: 12/706,004

(22) Filed: Feb. 16, 2010

(30) Foreign Application Priority Data
Feb. 17, 2009 (FR) 0951026

(51) Int. Cl. G06K 9/00; G21K 4/00

(52) U.S. Cl. 382/132; 378/42

(57) ABSTRACT

A method for radiological imaging of a region of interest including blood vessels. The method has the steps of acquiring a real-time fluoroscopic image of the region of interest by exposing the region of interest to a first dose of X-rays, the fluoroscopic image showing background structures and instrument introduced into the vessels; subtracting a mask image from the acquired real-time fluoroscopic image to generate a subtracted fluoroscopic image showing only the instrument; combining the subtracted fluoroscopic image and a pre-recorded diagnostic image of the region of interest showing only the blood vessels to generate a combined image showing both the blood vessels and the instrument; and displaying the combined image on a screen for viewing. The mask image is determined from a fluoroscopic image acquired prior to the introduction of the instrument into the vessels by exposing the region to an X-ray does equivalent to the first dose.

### CROSS-REFERENCE TO RELATED APPLICATIONS

This application claims priority under 35 U.S.C. §§119(a)-(d) or (f) to prior-filed, co-pending French patent application number 0951026, filed on Feb. 17, 2009, which is hereby incorporated by reference in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

This invention relates to a method and a device for radiological imaging, which is intended for fluoroscopy-guided vascular surgery applications.

2. Description of Related Art

During a vascular surgery intervention, the surgeon introduces instruments (such as guides, catheters, stents) into the blood vessels and moves them to the lesion to be treated.

In order to be able to guide the movement of the instruments during the course of the intervention, the surgeon refers to images of the region being treated. These images include on the one hand, an image of the mapping of the blood vessels (referred to as a “roadmap”), which was acquired prior to the intervention, and on the other hand, a fluoroscopic image acquired in real time during the course of the intervention, this fluoroscopic image showing the instruments and background structures (such as bones and soft tissues) of the region being treated.

Techniques have been proposed for showing on a single image the position of the instruments and a mapping of the blood vessels, so that the surgeon might be able to directly view the position of the instruments in relation to the blood vessels.

The document EP 0 463 533 A1 describes a method of acquiring images for the purpose of a percutaneous transluminal coronary angioplasty intervention (PCTA), consisting in acquiring and storing an opacified image, and in acquiring a real-time fluoroscopic image. The opacified image and the real-time image are superimposed as one and the same image and the resulting superimposed image is displayed on a screen in order to be viewed by the radiologist. This document indicates that the radiologist can adjust the superposition by modifying the weights assigned to each image in the superposition. For example, if the radiologist is interested exclusively in the fluoroscopic information, the weight of the images can be adjusted so that the real-time information dominates in the displayed image. If the radiologist is likewise interested in the mapping information, the weight of the images can be adjusted whereby the fluoroscopic and mapping information are both presented in the displayed image.

However, the method described in this document does not enable the background structures and the instruments which appear in the fluoroscopic image to be weighted separately. Such being the case, the background structures may have a density such that these structures make it difficult to view the instruments or vessels in the final displayed image.

The document FR 2 848 809 A1 describes a method for aiding vascular navigation, according to which a first mask (PO) representing so-called background structures and blood vessels, a second mask (M) presenting only so-called background structures, and a live acquired image (I_{L}) are combined so as to produce an image to be viewed (I_{V}). The combination makes it possible to produce an image to be viewed (I_{V}) in which only the mapping of the blood vessels and the instruments appears.

This document provides, in particular, for the first and second masks to be determined from a series of images (Iₙ) acquired during the course of a first step which precedes the introduction of the instruments into the blood vessels and during which a contrast medium is injected into the blood vessels.

However, this method requires the injection of a contrast medium at the start of the intervention. Such being the case, it is desirable to reduce to a maximum the doses of contrast media administered to the patient.

In order to avoid resorting to an injection of contrast medium at the start of the procedure, the invention aims to take advantage of diagnostic images already available.

As a matter of fact, diagnostic images showing the blood vessels are commonly acquired and recorded during the course of a preparatory phase, prior to the surgical intervention. These images are obtained by digital subtraction angiography (DSA) techniques and enable the surgeon to locate the lesion being treated and to establish a procedural process. These diagnostic images generally have a very good quality due to the fact that they are acquired by subjecting the region being treated to a significant dose of radiation (higher than the dose of radiation administered for acquiring real-time fluoroscopic images).

However, it proves to be difficult to obtain a satisfactory final image by subtracting the real-time fluoroscopic images from the diagnostic images. As a matter of fact, since these images were acquired with different radiation spectra, the subtraction thereof inevitably produces artefacts in the final composite image. Such being the case, such artefacts are not acceptable to the surgeon.

One foreseeable solution would consist in applying a pre-processing to the real-time fluoroscopic images and to the diagnostic images, in order to adjust the grey levels thereof. However, this type of pre-processing is complicated to implement and does not necessarily lead to a satisfactory result.

### BRIEF SUMMARY OF THE INVENTION

One purpose of the invention is to propose a radiological imaging method enabling real-time generation of a guiding image showing both the blood vessels and the implement by using one or more pre-recorded diagnostic images.

This problem is solved in one embodiment by a method for radiological imaging of a region of interest including blood vessels, the method includes acquiring a real-time fluoroscopic image of the region of interest by exposing the region of interest to a first dose of X-rays, the fluoroscopic image showing background structures and at least one instrument introduced into the vessels; subtracting a mask image from the acquired real-time fluoroscopic image, in order to generate a subtracted fluoroscopic image showing only the instrument; combining the subtracted fluoroscopic image and a pre-recorded diagnostic image of the region of interest showing only the blood vessels, in order to generate a combined image showing both the blood vessels and the instrument; and displaying the combined image on a screen in order to enable viewing. The mask image is determined from at least one fluoroscopic image acquired prior to the introduction of the instrument into the vessels, by exposing the region to an X-ray dose equivalent to the first dose.

Due to the fact that the mask image was obtained with an X-ray dose equivalent to the first dose used for acquisition of the real-time fluoroscopic image, the subtraction step generates few artefacts. It is thus possible to produce a high-quality subtracted fluoroscopic image. The subtraction step does not require any complicated image pre-processing step.

The proposed method thus makes it possible to combine the subtracted fluoroscopic imaging showing only the instrument with a previously acquired diagnostic image showing only the vessels. This prevents having to resort to an injection of a contrast medium during the intervention phase.

The fluoroscopic image acquired prior to the introduction of the instrument is likewise acquired without any injection of a contrast medium.

Furthermore, the proposed method makes it possible to adjust the weighting of the instruments and blood vessels appearing in the combined image, independently of the background structures.

In one embodiment of the invention, the pre-recorded diagnostic image was obtained by exposing the region to a second dose of X-rays, which was higher than the first dose. This is the case when the diagnostic image is derived from a DSA diagnostic sequence.

In one embodiment of the invention, the method further includes preliminary steps of acquiring a series of fluoroscopic images prior to the introduction of the instrument into the blood vessels; and filtering the series of fluoroscopic images in order to generate the mask image.

More particularly, the step of acquiring the series of fluoroscopic images is carried out at the start of the intervention, over a brief time period of the order of one second, which precedes the introduction of the instrument into the blood vessels.

In one embodiment of the invention, the combining step includes the addition of the subtracted fluoroscopic image, the pre-recorded diagnostic image and an image showing only the background structures, each image being assigned an adjustable weighting coefficient. If necessary, this enables an overview of the background structures to be inserted into the combined image. As a matter of fact, these structures may comprise useful anatomical landmarks for positioning the instrument.

In one embodiment of the invention, the method further includes the steps of comparing the mask image with an image of the pre-recorded background structures; estimating a movement of the region of interest based on the comparison; and readjusting the pre-recorded diagnostic image based on the estimated movement.

In another embodiment, the invention likewise relates to a radiological imaging device, the device comprises an X-ray source capable of emitting X-rays according to a first dose; a detector capable of receiving X-rays emitted by the source and of generating real-time fluoroscopic image data representative of a region of interest positioned between the source and the detector; a processing unit capable of receiving the image data and programmed to execute the previously defined imaging method, so as to generate a combined image showing both blood vessels contained in the region of interest and at least one instrument introduced into the blood vessels; and a display device configured to display the combined image for viewing.

### BRIEF DESCRIPTION OF THE SEVERAL VIEWS OF THE DRAWINGS

Other characteristics and advantages will become further apparent from the following description, which is purely illustrative and non-limiting, and which should be read with reference to the appended figures, among which:

FIG. 1 is a schematic representation of an image acquisition device in accordance to one embodiment of the invention;

FIG. 2 is a schematic representation of the steps of a first phase of an imaging method in accordance with one embodiment of the invention;

FIG. 3 is a schematic representation of the steps of a second phase of an imaging method in accordance with one embodiment of the invention; and

FIG. 4 is a schematic diagram showing the processing of the images produced by the method.

### DETAILED DESCRIPTION OF THE INVENTION

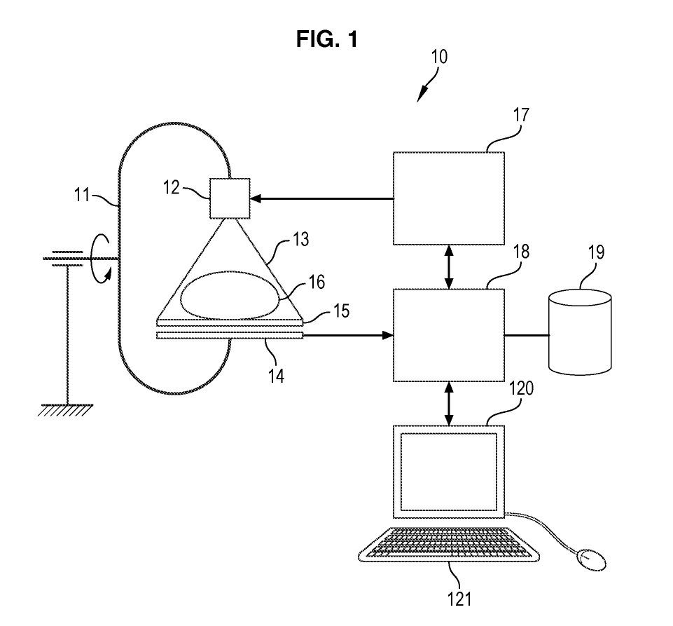

In FIG. 1, the device 10 shown includes a rotating arm 11 (C-arm), a source 12 fastened to one end of the rotating arm and capable of emitting radiation 13, and a detector 14 fastened to another end of the rotating arm and capable of receiving the radiation emitted by the source. The device 10 likewise includes a support 15 on which a patient can be arranged, the support being designed such that a region of interest 16 of the patient is situated between the source 12 and the detector 14. In this way, the detector 14 receives X-rays emitted by the source 12 after these X-rays have passed through the region of interest 16.

The acquisition device 10 includes a control unit 17 capable of controlling movement of the rotating arm 11 into various positions and of controlling the source 12 so that it emits radiation having a controlled level of energy.

The acquisition device 10 likewise includes computer processing unit 18 capable of receiving and processing image data acquired by the detector 14.

The detector 14 is capable of generating and of transmitting to the processing unit 18 a projection image in the form of data comprising a set of pixels, and for each pixel an associated grey level. The grey level is representative of the attenuation of the X-rays having passed through the various structures located in the region of interest 16.

Finally, the acquisition device 10 includes a memory unit 19 in which image data can be recorded, a display device 120 including a screen for displaying images to be viewed, as well as interface means 121 enabling the surgeon to control the processing means 18.

The processing means 18 are programmed to automatically execute steps of an imaging method in accordance with one embodiment of the invention.

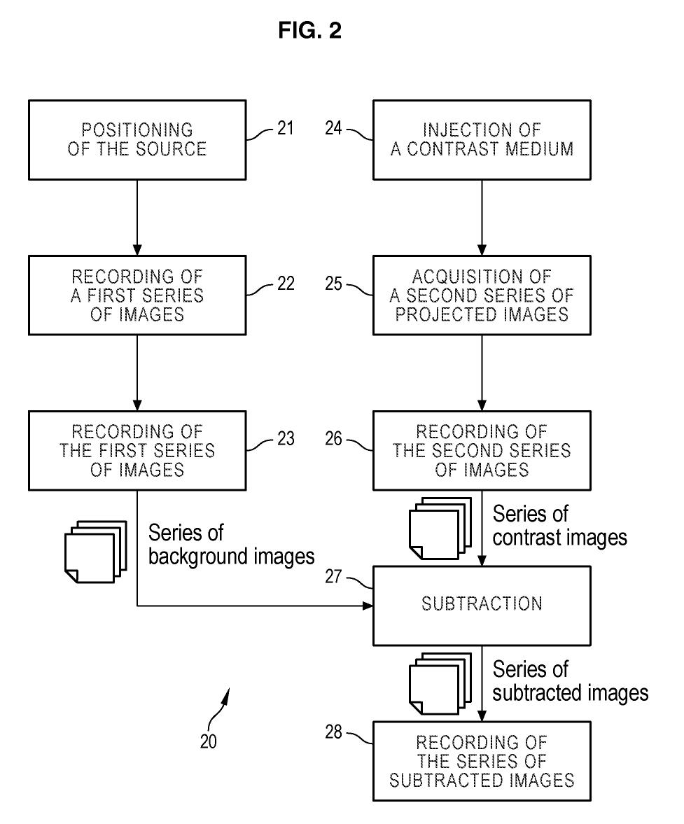

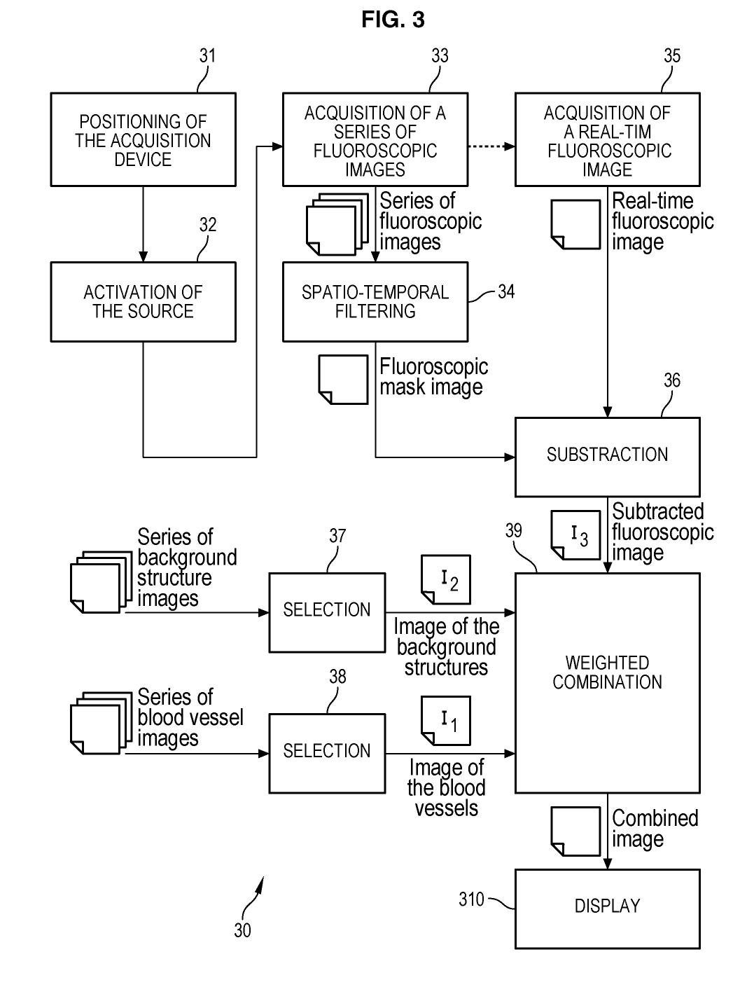

FIGS. 2 and 3 show various steps of the imaging method.

The imaging method includes two principle phases: a first preparatory phase 20, shown in FIG. 2, and a second real-time viewing phase 30, shown in FIG. 3. The two phases can be spaced apart in time, but are executed with the same acquisition device.

The purpose of the first phase 20 is to acquire a series of images of the blood vessels in the region of interest. This series of images enables the surgeon to view the blood vessels in order to locate the lesion being treated and to establish an intervention process.

The first phase 20 includes the following steps:

According to a first step 21, the control unit positions the source in a given position so that the source illuminates the region of interest.

According to a second step 22, while the source is held in the given position, the control unit activates the source so that the source emits a high-level radiation.

Simultaneously, the detector acquires image data and transmits the acquired data to the processing unit. The image data includes a series of projected images of the region of interest, without any contrast medium, showing background structures (bones, soft tissues).

According to a third step 23, the processing unit records the first series of acquired images in the memory unit.

According to a fourth step 24, a contrast medium is injected into the blood vessels located in the region of interest.

According to a fifth step 25, the control unit proceeds with activating the source so that the source emits a high-level radiation.

Simultaneously, the detector proceeds with acquiring the image data and transmits the image data to the processing unit. The image data includes a series of projected images of the region of interest which, on the one hand, show background structures (bones, soft tissues) and, on the other hand, the blood vessels which have been enhanced owing to the presence of the contrast medium.

According to a sixth step 26, the processing unit records the second series of acquired images in the memory unit.

According to a seventh step 27, the processing unit subtracts from the first series of images acquired without any contrast medium the subsequent second series of images acquired with a contrast medium.

This seventh step leads to the obtainment of a series of projected images showing only the blood vessels.

According to an eight step 28, the processing unit records the series of images showing the blood vessels in the memory unit.

The second phase 30 of the method is carried out during the surgical intervention. The purpose of this second phase is to directly display an image which simultaneously shows the background structures, the blood vessels as well as the instrument(s) inside the blood vessels.

According to a first step 31, the surgeon defines the positioning within the space of the acquisition device. To that end, the surgeon controls the processing unit using the interface means, in order to position the device in an acquisition position corresponding to the given acquisition position of the source during the first phase.

According to a second step 32, the control means activate the source so that the source emits a low-energy radiation.

According to a third step 33, over the course of a brief time period (of a duration less than or equal to one second), prior to the introduction of the instrument(s) into the blood vessels, the detector acquires image data and transmits the data to the processing unit. The image data includes a series of fluoroscopic images of the region of interest showing the background structures (bones, soft tissues), which were successively acquired during the brief time period.

According to a fourth step 34, the processing unit determines a fluoroscopic mask image from the series of fluoroscopic images. The fluoroscopic mask image is determined by applying a spatio-temporal filter to the series of fluoroscopic images, thereby enabling reduction of the noise in fluoroscopic mask image.

The spatio-temporal filter carries out two operations:

According to a first operation, a spatial filter is applied to each image independently. This first filtering operation, for example, consists in assigning an average grey level to each image pixel, which is equal to equal to a weighted average of the grey levels of the pixels situated in the vicinity of the pixel in question.

Other spatial filters can be implemented, such as a median filter or an adaptive filter, e.g., an adaptive filter.

According to a second operation, a temporal filter is applied to the series of images. This second filtering operation, for example, consists in assigning to each pixel of the fluoroscopic mask image a grey level, which equal to the average of the grey levels of the corresponding pixels in the various images of the series.

Of course, the first and second operations can be carried out in a different order.

Next, the surgeon introduces one or more instruments into the blood vessels of the region of interest.

According to a fifth step 35, the detector acquires image data and transmits the data to the processing unit. The image data includes a fluoroscopic image of the region of interest which is acquired in live and which shows the background structures and the instrument(s) introduced into the blood vessels.

According to a sixth step 36, the processing unit subtracts the fluoroscopic mask image from the live acquired fluoroscopic image. This step makes it possible to generate a subtracted fluoroscopic image showing only the instrument, the background structures having been eliminated.

Due to the fact that the real-time fluoroscopic image and the fluoroscopic mask image were acquired with the same doses of X-rays, the subtracted fluoroscopic image has few artefacts.

In parallel, according to a seventh step 37, the processing unit selects an image of the blood vessels (referred to as a “roadmap”) from the series of images showing the blood vessels, which was recorded in the memory unit.

And according to an eight step 38, the processing unit selects an image of the background structures from the series of images likewise recorded in the memory unit.

According to a ninth step 39, the processing unit generates a combined image from the selected image of the blood vessels, from the selected image of the background structures and from the subtracted fluoroscopic image of the instrument.

The combination operation consists of a weighted sum of these three images, in the form:
Combined image=ρ·I₁+λ·I₂+δ·I_{3.} where:
I₁represents the image data for the blood vessels,
I₂ represents the image data for the background structures,
I₃ represents the subtracted fluoroscopic image data for the implement, and
ρ, λ and δ are weighting coefficients assigned to each image I_{1.} I₂ and I₃.

The weighting coefficients ρ, λ and δ can be adjusted by the surgeon in order to make the blood vessels, the background structures or the instruments stand out more or less in the combined image. In this way, the intensity of the blood vessels, background structures and instruments can be adjusted independently based on the viewing needs.

The weighting coefficients ρ, λ and δ are by default real numbers between 0 and 1. However, the value of these coefficient can be greater than 1, if, for example, the surgeon desires magnification.

The addition operation with the factors is carried out pixel by pixel.

The coefficient λ associated with the image of the background structures can be equal to 0 so that the combined image shows only the blood vessels and the instrument. However, it may be necessary to likewise show an overview of the background structures in the final image, if the surgeon wishes to locate the position of the instruments in relation to certain anatomical landmarks. In this case, the coefficient λ is chosen to be non-zero.

According to a tenth step 3,10, the processing unit controls the display of the combined image on the display screen, in order to enable viewing by the surgeon.

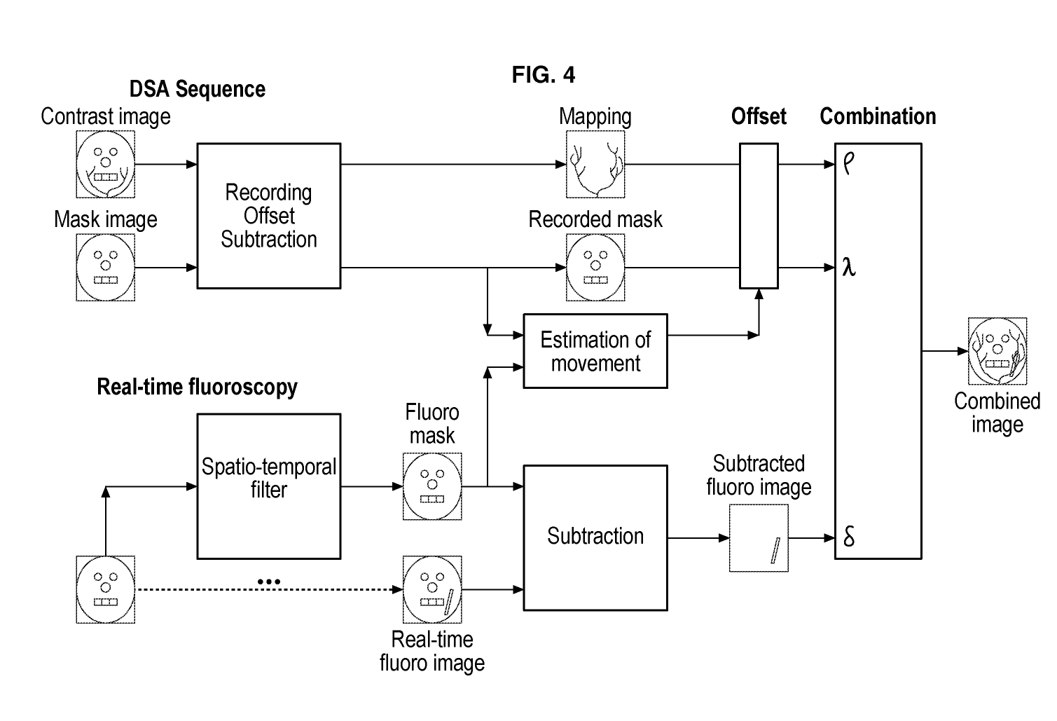

Furthermore, as illustrated in FIG. 4, the processing unit can compensate for small movements of the patient during the intervention. To that end, the processing unit compares the images of the background structures with the fluoroscopic mask image and estimates a movement of the patient. The processing unit computes a repositioning or a readjustment of the image of the blood vessels based on the estimated movement.

The method just described provides for the subtraction operations to be carried out only between images acquired with the same X-ray doses. This makes it possible to prevent the generation of artefacts due to a sensitivity of certain structures to the X-ray dose (which is expressed by an absorption coefficient which varies in relation to the radiation energy).

The method eliminates the need to resort to an adjustment of the high-dose and low-dose images acquired, since the combination step is applied to subtracted images exempt from any sensitive structures. This method makes it possible to generate a high-quality combined image.

The DSA phase (first phase) can be carried out with a field of view (FOV) different from the field of view of the procedural fluoroscopic phase (second phase), since the combination step is carried out from a real-time fluoroscopic image (I₃) and images (I₁ and I₂) which can be adapted at will (enlargement, framing, etc.).

The various gains ρ, λ and δ can be modified during the course of the procedure, based on the surgeon's preferences.

What is claimed is:

1. A method for radiological imaging of a region of interest including blood vessels, the method comprising the steps of:
acquiring a real-time fluoroscopic image of the region of interest by exposing the region of interest to a first dose of X-rays, the fluoroscopic image showing background structures and at least one instrument introduced into the vessels;
subtracting a mask image from the acquired real-time fluoroscopic image, in order to generate a subtracted fluoroscopic image showing only the instrument;
combining the subtracted fluoroscopic image and a pre-recorded diagnostic image of the region of interest showing only the blood vessels, in order to generate a combined image showing both the blood vessels and the instrument; and
displaying the combined image on a screen in order to enable viewing,
wherein the mask image is determined from at least one fluoroscopic image acquired prior to the introduction of the instrument into the vessels, by exposing the region to an X-ray dose equivalent to the first dose.

2. The method of claim 1, wherein the pre-recorded diagnostic image was obtained by exposing the region to a second X-ray dose, which is greater than the first dose.

3. The method of claim 1, wherein the fluoroscopic image acquired prior to the introduction of the instrument is acquired without any injection of a contrast medium.

4. The method of claim 1, further comprising preliminary steps of:
acquiring a series of fluoroscopic images prior to the introduction of the instrument into the blood vessels; and
filtering the series of fluoroscopic images in order to generate the mask image.

5. The method of claim 4, wherein the step of acquiring the series of fluoroscopic images is carried out, during a brief time period of the order of one second, which precedes the introduction of the instrument into the blood vessels.

6. The method of claim 1, wherein the combining step includes the addition of the subtracted fluoroscopic image, the pre-recorded diagnostic image and an image showing only the background structures, each image being assigned an adjustable weighting coefficient.

7. The method of claim 1, further comprising the steps of:
comparing the mask image with an image of the pre-recorded background structures;
estimating a movement of the region of interest based on the comparison; and
re-adjusting the pre-recorded diagnostic image based on the estimated movement.

8. A radiological imaging device, the device comprising:
an X-ray source capable of emitting X-rays according to a first dose;
a detector capable of receiving X-rays emitted by the source and of generating real-time fluoroscopic image data representative of a region of interest positioned between the source and the detector;
a processing unit capable of receiving the image data and programmed to execute the steps of the method as claimed in claim 1, so as to generate a combined image showing both blood vessels contained in the region of interest and at least one instrument introduced into the blood vessels; and
a display device configured to display the combined image for viewing.
